(19) United States
(12) Patent Application Publication
(10) Pub. No.: US 2005/0086460 A1
(43) Pub. Date: Apr. 21, 2005

(54) Apparatus and method for wakeup on LAN

(76) Inventor: Chang-Shu Huang, Taipei (TW)

Correspondence Address: HOFFMAN, WASSON & GITLER,P.C., Suite 522, 2361 Jefferson Davis Highway, Arlington, VA, 22202, US

(21) Appl. No.: 10/684,365

(22) Filed: Oct. 15, 2003

(51) Int. Cl. G06F 9/00; G06F 9/24; G06F 9/445; H04L 12/28; H04L 12/56; G06F 15/16

(52) U.S. Cl. 713/2; 370/908; 709/250

(57) ABSTRACT

An apparatus for wakeup on LAN (WOL) has a programmable control apparatus, a computer system and an interface device. The interface device sends a power management event (PME) signal to the programmable control apparatus and the computer system, separately, after receiving a WOL package. When the computer system receives the PME signal during its normal state, such as a sleep mode or a running mode, the computer system in the sleep mode is restored to the running mode, and the computer system in the running mode keeps running. When the computer system receives the PME signal during an abnormal off state, such as a halt mode or its power being cut off abnormally, a reset module of the programmable control apparatus resets the computer system.

### BACKGROUND OF THE INVENTION

1. Field of Invention

The present invention relates to an apparatus and a method for wakeup on LAN. More particularly, the present invention relates to an apparatus and a method for wakeup on LAN for resetting the computer system while in the abnormal off state.

2. Description of Related Art

A wakeup on local area network (LAN) technique is developed for a user waking up a remote computer system through a remote server. A network interface card, used in the computer system, must have a capability of being woken up by the remote server, such that the computer system has the wakeup on LAN (WOL) function.

Generally, power sources provided for the computer system can be, divided into two types, a core power source and a suspend power source. When the power line of the computer system is plugged into AC power, the suspend power source supplies power to the computer system even when the computer system is not yet turned on. Moreover, when the computer system is turned on, if the computer system detects some devices as being unused, the computer system can set a power mode of the devices into a suspend state, supplying power from the suspend power source instead the core power source to conserve power.

When the computer system is turned on, a basic input/output system (BIOS) carries out an advanced configuration and power interface (ACPI) routine, to manage perfectly the power of the computer system. While the computer system is running, an operating system thereof can selectively turn off unused peripherals, or commands the computer system to enter a sleep mode. When the user uses a keyboard or moves a mouse thereof, the ACPI routine automatically restores the computer system to power supplied by the core power source.

The foregoing step of restoring the computer system to power supplied by the core power source also can be carried out by the method of wakeup on LAN. A wakeup on LAN package is sent to the network interface card through the remote server in a network system. After receiving the wakeup on LAN package, the network interface card sends a signal, namely a power management event (PME), to a south bridge chip in the computer system to wake up the computer system.

The south bridge chip of the computer can be set to be able to receive the power management event signal from the network interface card merely after the ACPI routine has been carried out by BIOS. In other words, the south bridge chip is set after the user presses the power button of the computer system and the computer system then finishes the turning on routines, such as the ACPI routine. Moreover, a large current from the core power source is needed to set the south bridge chip, and that cannot be supplied by the suspend power source. Conventionally, if the computer system is off, the south bridge chip thereof can't respond to the power management event sent from the network interface card, so at this time the computer can't be woken up by the wakeup on LAN method. In conclusion, the conventional computer system does not have the function of wakeup on LAN unless it has been turned on completely.

In addition, when the computer system is already turned on, and also is set to has the capability of being waken by the wakeup on LAN method, but the computer system has fallen into an abnormal off state, such as being halted or the AC power thereof being cut off abnormally, the computer system is therefore incapable of responding to the foregoing power management event. Although the suspend power source of the computer system still survives at this time, the computer system can't be woken up by a wakeup on LAN package of a remote server. The conventional solution recovers the computer system from the abnormal off state and has the function of wakeup on LAN again merely by manually pressing the power button of the computer system to reset the computer system and also reset the south bridge chip.

### SUMMARY OF THE INVENTION

When the computer system is used to form a server system, the server system usually includes multiple computer systems configured on racks. If one of the computer systems is in the abnormal off state, the user resets the abnormal off computer system with difficulty.

It is therefore an objective of the present invention to provide an apparatus for wakeup on LAN that provides a programmable control apparatus thereof to reset the computer system when the abnormal off computer system is woken up by the wakeup on LAN method.

It is another an objective of the present invention to provide a method for wakeup on LAN that determines whether to reset the computer system by the wakeup on LAN method according to a system health data obtained from the method monitoring the computer system while the computer system is in an abnormal off state.

It is still another an objective of the present invention to provide a method for wakeup on LAN that takes different responses in accordance with different states of the computer system, to improve a drawback of the conventional wakeup on LAN technique which can't wake up the computers in the abnormal off state.

It is still another an objective of the present invention to provide a programmable control apparatus, confirming if the computer system is in the normal state by a handshaking protocol therebetween. When the computer system is not in the normal state, the programmable control apparatus resets the computer system.

In accordance with the foregoing and other objectives of the present invention, an apparatus for wakeup on LAN is described. The apparatus has a programmable control apparatus, a computer system and an interface device. The interface device sends a power management event (PME) signal to the programmable control apparatus and the computer system, separately, after receiving a wakeup on LAN package. When the computer system receives the power management event signal during its normal state, such as a sleep mode or a running mode, the computer system in the sleep mode is restored to the running mode, and the computer system in the running mode keeps running. When the computer system receives the power management event signal during an abnormal off state, such as a halt mode or its power being cut off abnormally, the south bridge chip of the computer system can't respond to the power management event signal while the computer system is receiving the power management event signal.

The programmable control apparatus has a receiving module, a handshaking module and a reset module. The receiving module receives the power management event signal from the interface device. An operating logic of the programmable control apparatus is the handshaking thereof communicating with the computer system by a handshaking protocol to determine that the computer system is in the normal state or the abnormal off state. When the programmable control apparatus receives the power management event signal, and the computer system is in the normal state, the programmable control apparatus does not reset the computer system. When the programmable control apparatus receives the power management event signal, and the computer system is in the abnormal off state, the programmable control apparatus resets the computer system by the reset module.

In one preferred embodiment of the present invention, the interface device is a network interface card. Moreover, the programmable control apparatus is a baseboard management controller chip, usually is an 8051 chip configured directly on a mainboard of the computer system, for monitoring a system health state of the computer system and generating a system health data. The computer system in this embodiment receives the foregoing power management event signal by a south bridge chip thereof. When the handshaking module detects the computer system is in the abnormal off state, and cooperating with the system health data, the invention can determine if the computer system should be reset by a wakeup on LAN package at this time.

In this preferred embodiment, the handshaking protocol is carries out with a register. The programmable control apparatus is set to send a first signal, and the computer system is set to send a second signal. The first signal and the second signal interlacedly write into the register, and the logic levels of the two signals are opposite. Therefore, when the logic level of a data stored in the register is the same as the logic level of the first signal, the computer system does not change the logic level of the data, and the computer system is acknowledged as being in the abnormal off state.

In conclusion, by the operating logic setup in the programmable control apparatus of the invention, a server manager or a central control program of a remote server can directly reset the computer system in the abnormal off state with the wakeup on LAN package. Furthermore, before the step of resetting the computer system, the monitoring module of the programmable control apparatus is provided to check if any hardware device of the computer system is broken. Thus the invention prevents the computer system with the broken hardware device from causing larger loss, and also resolves the problem of resetting one of the multiple computer systems configured in the racks.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 illustrates a schematic view of one preferred embodiment of the invention;

FIG. 2 illustrates a flow chart of the preferred embodiment in FIG. 1;

FIG. 3 illustrates a flow chart of an operating logic of the programmable control apparatus of the invention;

FIG. 4 illustrates a schematic view of one preferred embodiment of the handshaking protocol used in the invention;

FIG. 5 illustrates a schematic view of another preferred embodiment of the invention; and

FIG. 6 illustrates a flow chart of the preferred embodiment in FIG. 5.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Two embodiments are described as follow to interpret the apparatus for wakeup on LAN of the invention. In the two embodiments, the normal state of the computer system includes a running mode and a sleep mode, and the sleep mode includes a softoff mode and a suspend mode of the operation of the computer system. Moreover, the abnormal state of the computer system includes the computer system being halted and the AC power thereof being cut off abnormally.

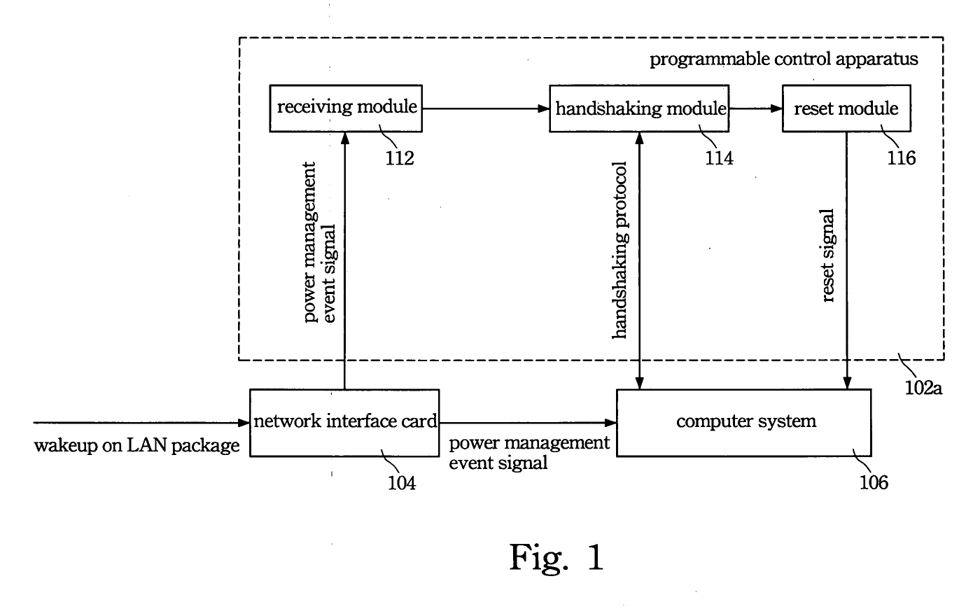

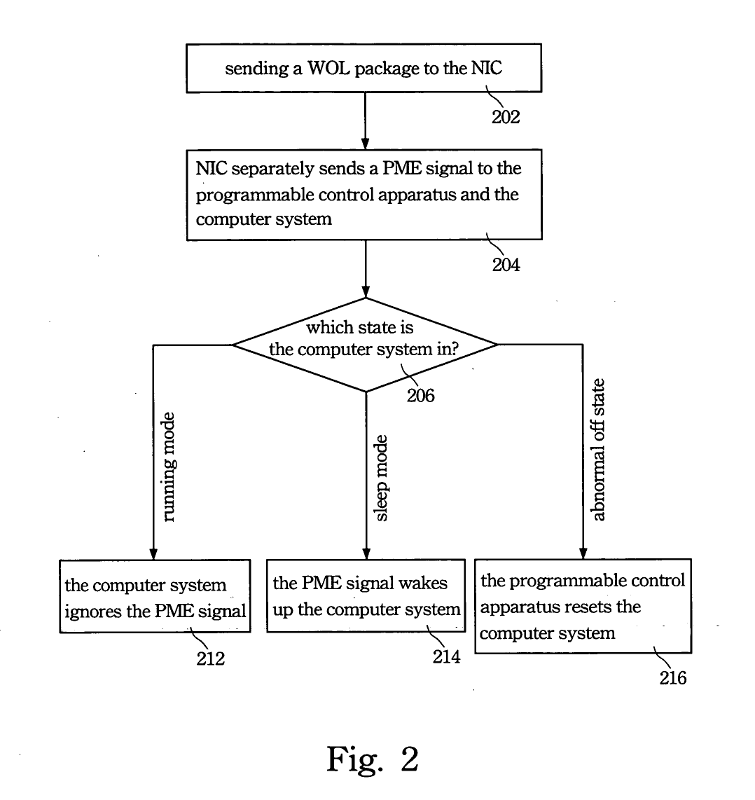

FIG. 1 illustrates a schematic view of one preferred embodiment of the invention, and FIG. 2 illustrates a flow chart of the preferred embodiment in FIG. 1. Following descriptions are referred to FIG. 1 and FIG. 2.

A remote server in a network system firstly sends a wakeup on LAN package to a network interface card 104 (step 202). After receiving the wakeup on LAN package, the network interface card 104 sends a signal, a power management event signal, separately to a programmable control apparatus 102a and a computer system 106 (step 204).

In this embodiment, the computer system 106 receives the power management event signal from the network interface card 104 by a south bridge chip thereof (not illustrated in FIG. 1). The invention takes different responses to different states in which the computer system 106 is. When the computer system 106 is in the running mode, the south bridge chip ignores the power management event signal, and the computer system 106 keeps running (step 212). When the computer system 106 is in the sleep mode, the south bridge chip wakes up the computer system 106 while receiving the power management event signal, and the computer system 106 is restarted and restored to the running mode (step 214).

When the computer system 106 is in the abnormal off state, such as the computer system 106 being halted and the AC power thereof being cut off abnormally, the south bridge chip can't respond to the power management event signal when the computer system 116 receives the power management event signal. On the other hand, a programmable control apparatus 102a of the invention resets the computer system 116 by a reset module 116 thereof (step 216). The details of the programmable control apparatus 102a are described as follows.

The programmable control apparatus 102a has a receiving module 112, a handshaking module 114 and the reset module 116. The receiving module 112 receives the power management event signal from the interface device 104. The handshaking module 114 communicates with the computer system 106 by a handshaking protocol to determine whether the computer system 106 is in the normal state or in the abnormal off state. The handshaking protocol used in the invention is described in the following description.

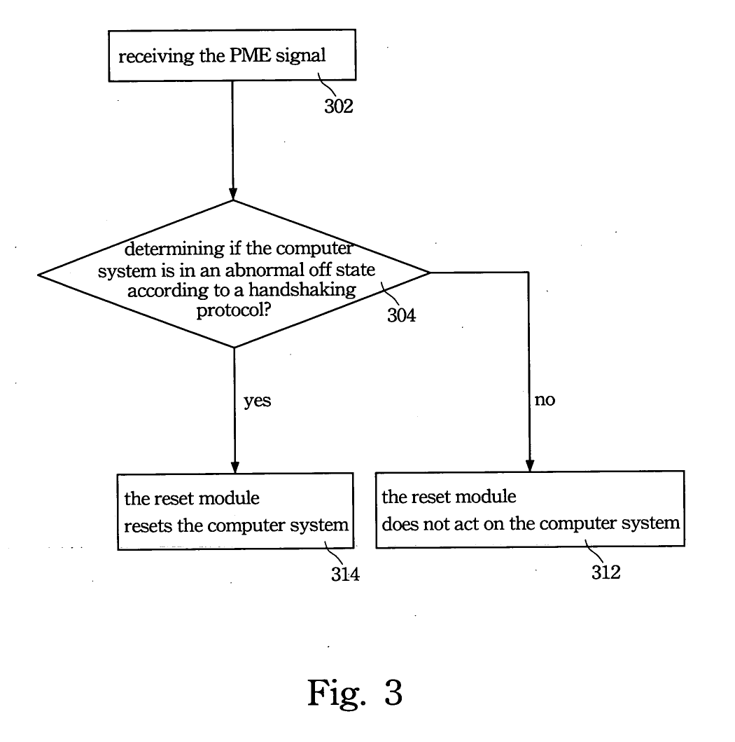

FIG. 3 illustrates a flow chart of an operating logic of the programmable control apparatus of the invention. When the programmable control apparatus 102a receives the power management event signal (step 302), and the computer system 106 is determined as being in the normal state by the handshaking 114 (step 304), the programmable control apparatus 102a does not reset the computer system 106 (step 312). When the programmable control apparatus 102a receives the power management event signal (step 302), and the computer system 106 is determined as being in the abnormal off state by the handshaking module 114 (step 304), the programmable control apparatus 112a resets the computer system by the reset module (step 314).

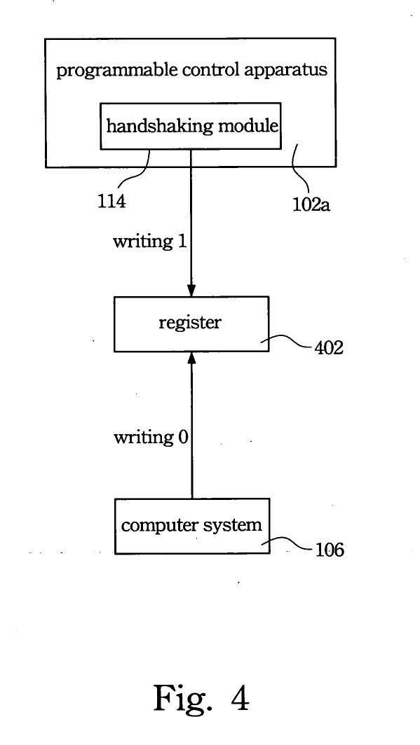

FIG. 4 illustrates a schematic view of one preferred embodiment of the handshaking protocol used in the invention. In this embodiment, the handshaking protocol is carries out with a register 402. The programmable control apparatus 102a is set to send a first signal having a high logic level 1, and the computer system 106 is set to send a second signal having a low logic level 0. The first signal and the second signal interlacedly write into the register 402.

Therefore, when the logic level of a data stored in the register 402 is the same as the logic level (high logic level 1) of the first signal, and is not changed by the computer system 106 as the logic level (low logic level 0) of the second signal, the computer system 106 is acknowledged as being in the abnormal off state.

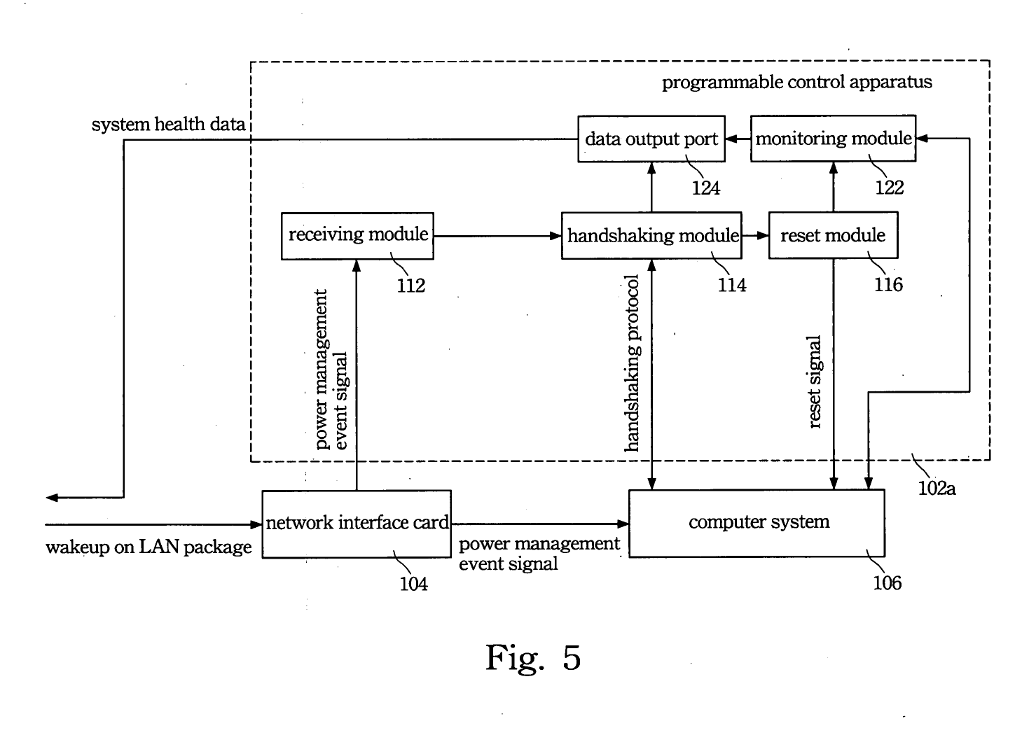

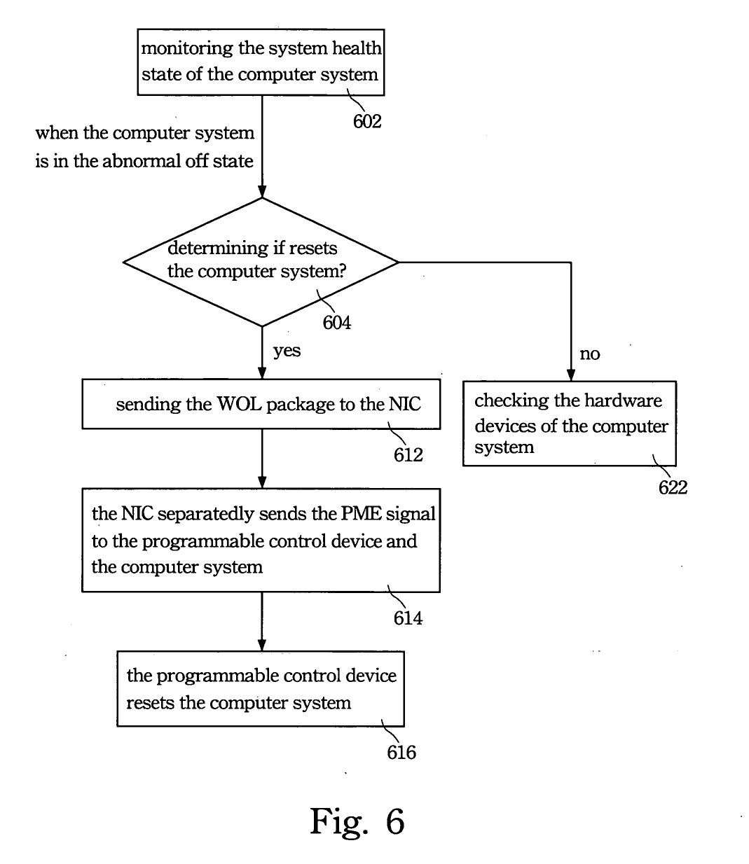

FIG. 5 illustrates a schematic view of another preferred embodiment of the invention, and FIG. 6 is a flow chart of the preferred embodiment in FIG. 5. The following descriptions refer to FIG. 5 and FIG. 6. The embodiment interprets how the invention is applied in a server system including multiple computer systems. When multiple computer systems are configured on the racks, and one of the computer systems is in the abnormal off state, the invention facilitates determination and resetting of the abnormal off computer system by a user.

Compared to the programmable control apparatus 102a in FIG. 1, a programmable control apparatus 102b in FIG. 5 further more has a monitoring module 122 and a data output port 124. In this embodiment, a baseboard management controller chip is taken as the programmable control apparatus 102b of the invention. The baseboard management controller chip usually is an 8051 chip configured directly on a mainboard of the computer system 106. The 8051 chip has a microprocessor, memories, and I/O ports itself, and is supplied power by the suspend power source. The baseboard management controller chip monitors and collects system health and system state of the computer system 106, and executes correcting actions thereon when a serious event occurs.

The system health monitoring function of the baseboard management controller chip is carried out by cooperation with several digital sensors. The digital sensors can detect and monitor voltages, temperatures and fan speeds of different portions of the computer system 106. The baseboard management controller chip inquires them actively and by turns for checking if any of several sensors connected thereto exceeds the normal range.

Moreover, for ascertaining that the monitoring is effective, the baseboard management controller chip can be set to take different corresponding actions according to different threshold values. For example, when the baseboard management controller chip detects that the temperature of one sensor exceeds a warning threshold value, the management controller chip increases the speed of a fan corresponding to the sensor. Furthermore, if the effect of the foregoing correcting actions is not enough, and the temperature over the warning threshold value rises to another emergency threshold value, the baseboard management controller chip cuts off the system power, records the whole event, and sends a warning message to the remote server through the network.

The programmable control apparatus 102b monitors the system health state by the monitoring module 122, and sends the system health data to the remote server by the data output port 124 (step 602). When the computer system 106 is in the abnormal off state, a viewer of the remote server, such as a central control program or a server manager, can determine if the computer system 106 should be reset according to the system health data.

The following descriptions separately interpret how to determine if resets the computer system 106, especially according to the system health data. If the system health data of the computer system 106 shows that any hardware device of the computer system 106 is broken, such as the heat-dissipating fan thereof failing to dissipate heat, or any voltage of circuits thereof being incorrect, the hardware devices of the computer system 106 must be further checked and maintained, and not automatically reset.

In the other aspect, if the hardware devices of the computer system 106 are well, and the abnormal off state is just caused by a random noise or the supplied power is cut off without damaging any hardware devices thereof, the computer system 106 can be reset by sending a wakeup on LAN package to the network interface card 104 (step 612).

Similarly, the network interface card 104 sends separately the power management event signal to the programmable control apparatus 102b and the computer system 106 while receiving the wakeup on LAN package (step 614). However, because the computer system 106 is already in the abnormal off state, the power management event signal sent from the network interface card 104 does not act on the computer system 106.

In the other aspect, the programmable control apparatus 102b of the invention determines the computer system 106 is in the abnormal off state by the handshaking module 114. Therefore, when the receiving module 112 of the programmable control apparatus 102b receives the power management event signal from the network card 104, the programmable control apparatus 102b resets the computer system 106 by the reset module 116 thereof.

The programmable control apparatus can be a programmable control chip, directly configured on the mainboard of the computer system, as illustrate in the embodiment. In addition, according to another embodiments of the invention, the programmable control chip can also be configured on an interface card which is plugged in the computer system. Further, the programmable control apparatus of the invention can be configured in another external computer system, and using sensors and connecting lines to connect to the monitored and controlled computer system. It is noted that the invention also can be other programmable control apparatus, such as a circuit system on an interface card or a monitor/control program in an external computer system, all of which fit in the spirit and scope of the invention.

In conclusion, by the operating logic setup in the programmable control apparatus of the invention, a server manager or a central control program of a remote server can directly reset the computer system in the abnormal off state with the wakeup on LAN package. Furthermore, before the step of resetting the computer system, the monitoring module of the programmable control apparatus is provided to check if any hardware device of the computer system is broken. Thus the invention prevents the computer system with a broken hardware device from causing a larger loss, and also resolves the problem of resetting one of the multiple computer systems configured in the racks.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. An apparatus for wakeup on LAN, comprising:
a programmable control apparatus;
a computer system, connected to the programmable control apparatus; and
an interface device, separately connected to the programmable control apparatus and the computer system, wherein when the interface device receives a wakeup on LAN package, the interface device separately sends a management signal to the programmable control apparatus and the computer system;
wherein the programmable control apparatus determines if the computer system is in an abnormal off state according to a handshaking protocol, and when the computer system receives the management signal and is in the abnormal off state, the programmable control system sends a reset signal to the computer system to reset the computer system.

2. The apparatus of claim 1, wherein the programmable control apparatus is a programmable control chip.

3. The apparatus of claim 1, wherein the programmable control apparatus comprises a monitor module, monitoring a system health state of the computer system and generating a system health data.

4. The apparatus of claim 3, wherein the programmable control apparatus comprises a data output port, sending the system health data.

5. The apparatus of claim 1, wherein the computer system comprises a south bridge chip, receiving the management signal.

6. The apparatus of claim 1, wherein the interface device is a network interface card.

7. The apparatus of claim 1, wherein the management signal is a power management event signal.

8. A method for wakeup on LAN, comprising:
sending a wakeup on LAN package to an interface device; and
after receiving the wakeup on LAN package, the interface device separately sending a management signal to a programmable control apparatus and a computer system;
wherein when the computer system is in a running mode, the computer system ignores the management signal;
when the computer system is in a sleep mode, the computer system is woken up by the management signal; and
when the computer system is in an abnormal off state, the programmable control apparatus resets the computer system after receiving the management signal.

9. The method of claim 8, wherein the method further comprises determining whether the computer system is in a normal state or in the abnormal state by a handshaking protocol between the programmable control apparatus and the computer system, wherein the normal state comprises the running mode and the sleep mode.

10. The method of claim 9, wherein the step of the determining comprises:
sending a first signal by the programmable control apparatus and sending a second signal by the computer system for interlacedly writing into a register, wherein a logic level of the first signal is opposite to a logic level of the second signal;
wherein when a logic level of a data stored in the register remains identical to the logic level of the first signal, the computer system is in the abnormal off state.

11. The method of claim 8, wherein the method further comprises monitoring a system health state of the computer system and generating a system health data.

12. The method of claim 11, wherein the method further comprises determining whether to send the wakeup on LAN package according to the system health data.

13. The method of claim 8, wherein the computer system comprises a south bridge chip for receiving the management signal.

14. A programmable control apparatus, connected to a computer system, the programmable control apparatus comprising:
a receiving module, receiving a management signal from an interface device;
a handshaking module, communicating to the computer system with a handshaking protocol for determining if the computer system is in an abnormal off state; and
a reset module, sending a reset signal to the computer system, wherein when the programmable control apparatus determines the computer system is in the abnormal off state, and receives the management signal, the reset signal resets the computer system.

15. The programmable control apparatus of claim 14, wherein the programmable control apparatus sends a first signal and the computer system sends a second signal for interlacedly writing into a register, and a logic level of the first signal is opposite to a logic level of the second signal, wherein when a logic level of a data stored in the register remains identical to the logic level of the first signal, the computer system is in the abnormal off state.

16. The programmable control apparatus of claim 14, wherein the programmable control apparatus comprises:
a monitor module, monitoring a system health state of the computer system and generating a system health data; and
a data output port, sending the system health data.

17. The programmable control apparatus of claim 14, wherein the interface device is a network interface card.

18. The programmable control apparatus of claim 14, wherein the management signal is a power management event signal.
